(19) United States
(12) Patent Application Publication
(10) Pub. No.: US 2004/0199485 A1
(43) Pub. Date: Oct. 7, 2004

(54) Index for directory database

(75) Inventor: Thomas J. Caswell, Apex, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/405,674

(22) Filed: Apr. 1, 2003

(51) Int. Cl. G06F 7/00

(52) U.S. Cl. 707/1

(57) ABSTRACT

Techniques are disclosed for creating an efficient index for a directory database (such as a Lightweight Directory Access Protocol, or “LDAP”, directory). The index includes an entry for each unique attribute type at each level of a Directory Information Tree (“DIT”) that represents the distinguished names of entries present in the directory. The attribute values are omitted when creating the index. The index requires less storage and memory than the DIT, and can be traversed more quickly. Entries in the index can be tagged with information in an application-specific manner. The tagged data may enable an application to quickly determine information about directory entries having a particular distinguished name structure.

### BACKGROUND OF THE INVENTION

1. Field of the Invention

The present invention relates to a computer system, and deals more particularly with techniques for programmatically creating an index for a directory database (such as a Lightweight Directory Access Protocol, or “LDAP”, directory).

2. Description of the Related Art

“Directory database”, or simply “directory”, is a term known in the art that reflects the recent trend of using the information stored in a data repository as an on-line directory of information. The term “on-line directory service”, or simply “directory service”, is also sometimes used, and refers generically to a repository of information, along with the access methods and other services that are used with the repository.

A particular approach to implementation of a directory service is specified as an international standard in ISO/IEC 9594-1, “The Directory: Overview of Concepts, Models, and Services” (1995), which is also published as ITU Recommendation X.500. An “X.500 Directory” is a directory service according to these specifications. X.500 directories are widely used in the Internet and Web for providing centralized storage and management of information.

A directory protocol is used to access the stored information in an on-line directory. A popular example of such a protocol is the Lightweight Directory Access Protocol or “LDAP”. The term “LDAP directory” refers generally to directories accessible using this protocol. (LDAP directories may be considered as alternatives to X.500 directories.) LDAP allows issuing queries (i.e., read operations) to the database as well as transmitting updates (i.e., write operations) thereto. Version 3 of LDAP is specified as Internet Engineering Task Force (“IETF”) Request For Comments (“RFC”) 2251.

An enterprise may specify information about a number of resources in an LDAP directory, enabling clients of the directory service to query the directory regarding those resources. Tivoli SecureWay® Software from International Business Machines Corporation (“IBM®)”), for example, provides directory services that support client queries for locating people, information, and applications within a network. (“SecureWay” and “IBM” are registered trademarks of International Business Machines Corporation.)

An LDAP Directory Information Tree, or “DIT”, is a hierarchical (i.e., tree-structured) representation of data in an LDAP directory. Each data element in the DIT is qualified with a distinguished name (“DN”), where this distinguished name represents an entry present in the directory and is uniquely identifiable. Distinguished names (“DNs”) use a well-known syntax that is described in IETF RFC 1779, titled “A String Representation of Distinguished Names”, the details of which are well known to those of skill in the art. Information may be retrieved from a directory by specifying a unique DN in a query.

It is not unusual for an LDAP DIT to contain hundreds of thousands of distinguished names. There is no prior art way to provide an overview of the entire directory without making an exact copy.

FIG. 1 shows an example LDAP DIT 100. Each data element 105, 110, . . . 140 in an LDAP DIT is described by an (attribute type, attribute value) pair (which are referred to as “attributeType” and “attributeValue” in the LDAP protocol). In DIT 100, for example, the attribute type “o” (see element 105) is an abbreviation of “organization”; the attribute type “st” (see elements 110, 115) is an abbreviation of “state”; the attribute type “ou” (see elements 120, 125, 130) is an abbreviation of “organizational unit”; the attribute type “hw” (see element 130) is an abbreviation of “hardware”; and the attribute type “cn” (see elements 135, 140) is an abbreviation of “common name”. In LDAP DITs in general, the distinguished name for any element in the tree is built by starting from the node for that element and tracing the path upward to the root element (i.e., element 105, in this example). Thus, the distinguished name for the data element at leaf node 135 is “cn=Alice, ou=development, st=NC, o=acme”. The distinguished name for the data element at leaf node 130 is “hw=SiteServer, st=NC, o=acme”. These concepts are well known in the art.

The information that may be stored in each data element of the DIT is typically defined by an LDAP object class (which is referred to as “objectClass” in the LDAP protocol). For example, leaf node 135 may represent an instance of an object class such as “employee” or perhaps “person”. In either case, the object class may have attributes such as “surname”, “given name”, “telephone number”, “user password”, and so forth, in addition to “common name”. The LDAP attribute type used to build the distinguished name for a data element must be part of the LDAP object class used to create the data element. For instance, the object class used to create the distinguished name “cn=Alice, ou=development, st=NC, o=acme” for element 135 must contain the attribute type “cn”.

Several drawbacks exist for prior art LDAP directories. An LDAP application that proxies one or more LDAP servers, such as a load-balancing program, has to maintain an exact copy of each LDAP DIT for the load-balancing to be effective, and therefore the entire DIT must be mirrored so that all of the distinguished names in the directory can be managed. Because of the huge number of data elements that may be present in an LDAP directory, the volume of distinguished names can create large resource requirements (including storage and processing capacity).

In addition, a prior art DIT has no way to indicate any relationship between a distinguished name and the object class used to describe its data. The attribute type used to create the distinguished name must exist in the object class, as noted above, but the distinguished name's attribute type is not unique to an object class. Instead, the attribute type may exist in as many object classes as required. With reference to the DIT 100 in FIG. 1, for example, the object class for element 135 might be “employee”, but the DN for this element (“cn=Alice, ou=development, st=NC, o=acme”) cannot be used to determine this object class. An identically-structured DN might be used where the object class is “spouse” or “person”, for example. Furthermore, if element 130 represents installed hardware resources at a physical location, then child nodes (not shown in FIG. 1) might be defined to identify the system administrators of those hardware resources. In that case, the child nodes may also contain an attribute type of “cn” for the system administrators, thereby reusing the attribute type for a different object class that appears at a different place within the DIT.

Accordingly, what is needed are techniques for addressing prior art limitations of directory information trees.

### SUMMARY OF THE INVENTION

An object of the present invention is to provide techniques for addressing prior art limitations of directory information trees.

It is another object of the present invention to provide an efficient directory index.

Another object of the present invention is to provide techniques for creating a directory index by collapsing a DIT structure to eliminate non-essential data.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for creating an index for data stored in a directory. In preferred embodiments, this technique comprises: programmatically determining, for each level of a multi-level hierarchy representing entries in a directory, each unique attribute type used by the entries at that level; and programmatically building a multi-level hierarchical index, where each level of the hierarchical index contains an entry for each of the programmatically-determined unique attributes types in a corresponding level of the multi-level hierarchy representing the entries in the directory.

In preferred embodiments, the attribute values corresponding to the attribute types are not copied from the multi-level hierarchy representing the entries in the directory to the entries in the multi-level hierarchical index. In one aspect, the technique may further comprise tagging one or more selected entries of the index with information pertinent to the selected entry. This pertinent information may (as one example) identify one or more servers that store, in entries of the directory, information accessible using one or more parameters that include the attribute type of the selected entry of the index. The pertinent information may be usable as a trigger for selectively invoking functionality (for example, when a query is issued to the directory and the query specifies one or more parameters that include the attribute type of the selected entry of the index).

By way of example, the directory may be an LDAP directory.

The present invention may also be used advantageously in methods of doing business, for example by providing an indexed access service or an index-building service for clients. Such services may be provided under various revenue models, such as pay-per-use billing, monthly or other periodic billing, and so forth.

The present invention will now be described with reference to the following drawings, in which like reference numbers denote the same element throughout.

### BRIEF DESCRIPTION OF THE DRAWINGS

FIG. 1 illustrates an example DIT, according to the prior art;

FIG. 2 is a block diagram of a computer hardware environment in which the present invention may be practiced;

FIG. 3 is a diagram of a networked computing environment in which the present invention may be practiced;

FIGS. 4A-4D depict how a DIT index may be created for the example DIT of FIG. 1, according to preferred embodiments;

FIG. 5 provides another sample DIT, using prior art techniques; and

FIG. 6 depicts a DIT index that may be created for the DIT of FIG. 5, according to preferred embodiments of the present invention.

### DESCRIPTION OF PREFERRED EMBODIMENTS

As stated earlier, a directory may contain hundreds of thousands of entries. Accordingly, the DIT of the prior art may require a considerable amount of storage space, with that space being duplicated in environments where applications such as load balancing of directory services are deployed, and traversing a prior art DIT (e.g., when accessing the directory) may consume a considerable amount of processing resources. Furthermore, memory consumption required for traversing a prior art DIT is also significant in many cases.

The present invention discloses an LDAP “DIT index”, where this index is a mechanism for compressing an LDAP DIT into a smaller index of more manageable size. The DIT index requires less storage (and memory) space, and may be traversed more quickly, than the prior art DIT. The compressed index may be used advantageously, for example, at an LDAP proxy such as a server that performs a routing function for inbound queries. This server need only store a copy of the DIT index (instead of the entire DIT), yet can still have sufficient information for carrying out its routing function.

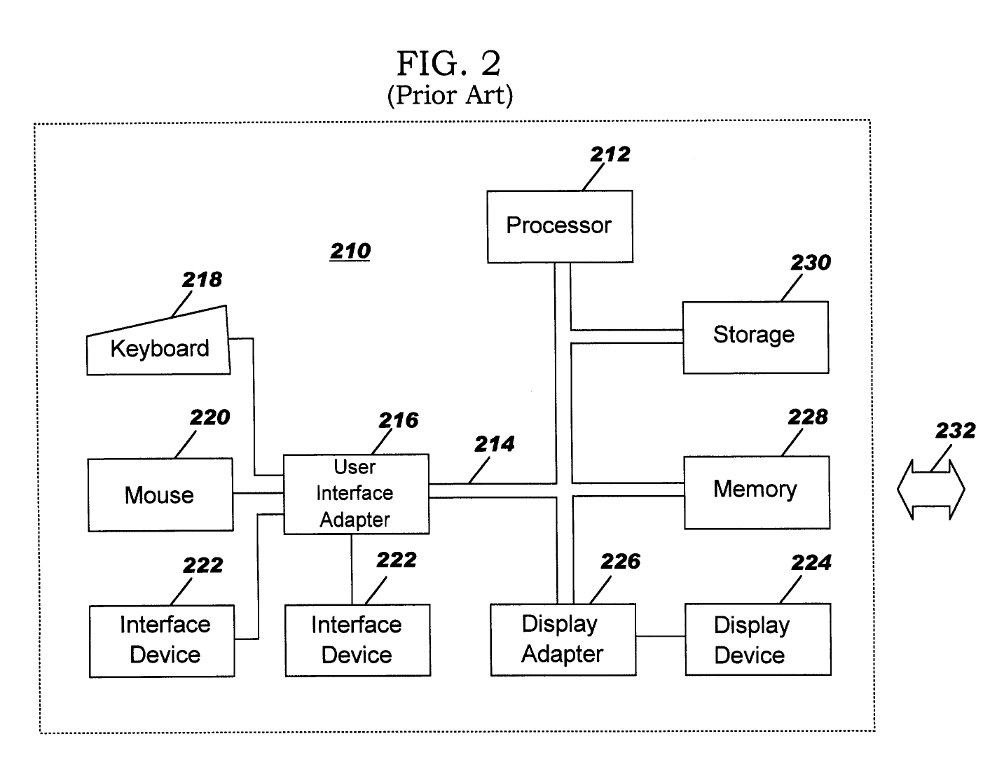

FIG. 2 illustrates a representative computer hardware environment in which the present invention may be practiced. The device 210 illustrated therein may be a personal computer, a laptop computer, a server or mainframe, and so forth. The device 210 typically includes a microprocessor 212 and a bus 214 employed to connect and enable communication between the microprocessor 212 and the components of the device 210 in accordance with known techniques. The device 210 typically includes a user interface adapter 216, which connects the microprocessor 212 via the bus 214 to one or more interface devices, such as a keyboard 218, mouse 220, and/or other interface devices 222 (such as a touch sensitive screen, digitized entry pad, etc.). The bus 214 also connects a display device 224, such as a liquid-crystal display (“LCD”) screen or monitor, to the microprocessor 212 via a display adapter 226. The bus 214 also connects the microprocessor 212 to memory 228 and long-term storage 230 which can include a hard drive, diskette drive, tape drive, etc.

The device 210 may communicate with other computers or networks of computers, for example via a communications channel or modem 232. Alternatively, the device 210 may communicate using a wireless interface at 32, such as a cellular digital packet data (“CDPD”) card. The device 210 may be associated with such other computers in a local area network (“LAN”) or a wide area network (“WAN”), or the device 210 can be a client in a client/server arrangement with another computer, etc. All of these configurations, as well as the appropriate communications hardware and software which enable their use, are known in the art.

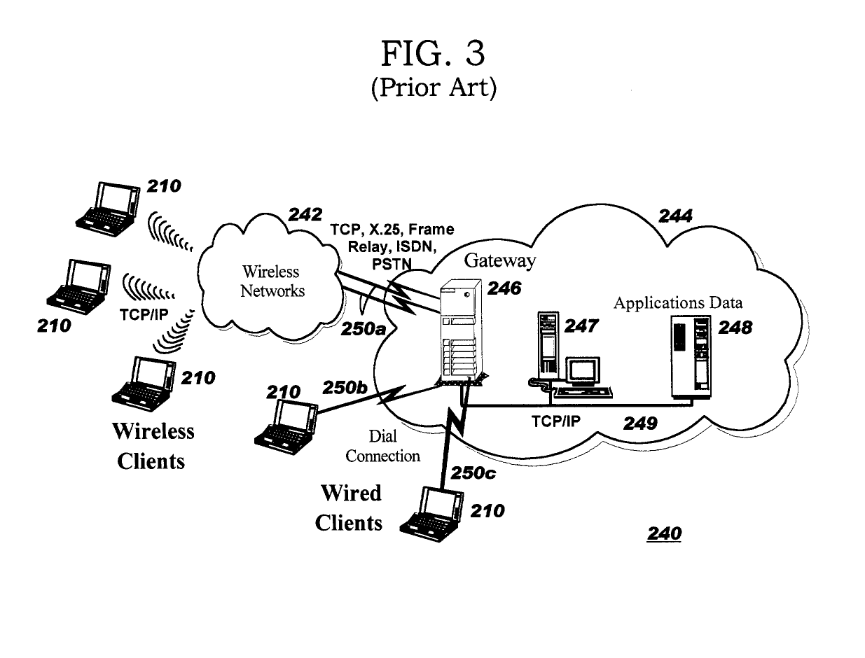

FIG. 3 illustrates a data processing network 240 in which the present invention may be practiced. The data processing network 240 may include a plurality of individual networks, such as wireless network 242 and network 244, each of which may include a plurality of devices 210. Additionally, as those skilled in the art will appreciate, one or more LANs may be included (not shown), where a LAN may comprise a plurality of intelligent workstations or similar devices coupled to a host processor.

Still referring to FIG. 3, the networks 242 and 244 may also include mainframe computers or servers, such as a gateway computer 246 or application server 247 (which may access a data repository 248). A gateway computer 246 serves as a point of entry into each network 244. The gateway 246 may be coupled to another network 242 by means of a communications link 250a. The gateway 246 may also be directly coupled to one or more devices 210 using a communications link 250b, 250c. Further, the gateway 246 may be indirectly coupled to one or more devices 210. The gateway computer 246 may also be coupled 249 to a storage device (such as data repository 248). The gateway computer 246 may be implemented utilizing an Enterprise Systems Architecture/370™ computer available from IBM, an Enterprise Systems Architecture/390® computer, etc. Depending on the application, a midrange computer, such as an Application System/400® (also known as an AS/400®) may be employed. (“Enterprise Systems Architecture/370” is a trademark of IBM; “Enterprise Systems Architecture/390”, “Application System/400”, and “AS/400” are registered trademarks of IBM.)

Those skilled in the art will appreciate that the gateway computer 246 may be located a great geographic distance from the network 242, and similarly, the devices 210 may be located a substantial distance from the networks 242 and 244. For example, the network 242 may be located in California, while the gateway 246 may be located in Texas, and one or more of the devices 210 may be located in Florida. The devices 210 may connect to the wireless network 242 using a networking protocol such as the Transmission Control Protocol/Internet Protocol (“TCP/IP”) over a number of alternative connection media, such as cellular phone, radio frequency networks, satellite networks, etc. The wireless network 242 preferably connects to the gateway 246 using a network connection 250a such as TCP or User Datagram Protocol (“UDP”) over IP, X.25, Frame Relay, Integrated Services Digital Network (“ISDN”), Public Switched Telephone Network (“PSTN”), etc. The devices 210 may alternatively connect directly to the gateway 246 using dial connections 250b or 250c. Further, the wireless network 242 and network 244 may connect to one or more other networks (not shown), in an analogous manner to that depicted in FIG. 3.

A directory may be installed on one or more devices in the network environment of FIG. 3. For example, application server 247 may include an LDAP directory. Or, application server 247 may access another device on which an LDAP directory is installed. Data repositories used by the LDAP directory may reside at one or more locations within the environment. (Note that the present invention may also be used with directory implementations which do not span more than one device.) Furthermore, LDAP directory facilities may be available on end-user devices such as device 210. The DIT index disclosed herein may appear at the same location(s) as the directory, or at one or more different locations.

Commercial LDAP directory implementations are widely available, and are well known in the art. A detailed description of such implementations is therefore not deemed necessary for purposes of understanding the present invention. It should also be noted that the techniques of the present invention do not require changing the commercially-available LDAP directory implementation.

In preferred embodiments, the present invention is implemented in software. Software programming code which embodies the present invention is typically accessed by the microprocessor 212 (e.g., of device 210 or server 247) from long-term storage media 230 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 228, and accessed by the microprocessor 212 using the bus 214. The techniques and methods for embodying software programming code in memory, on physical media, and/or distributing software code via networks are well known and will not be further discussed herein.

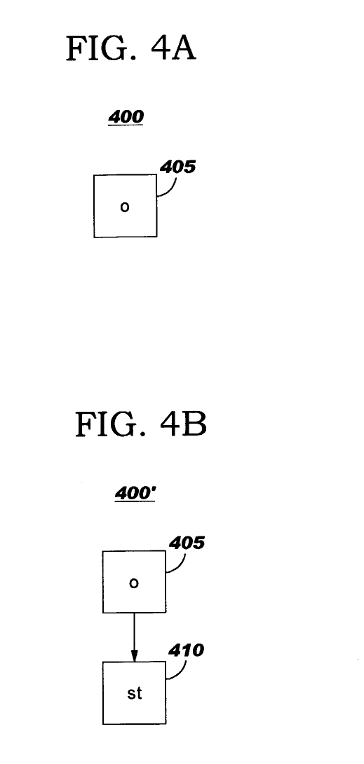

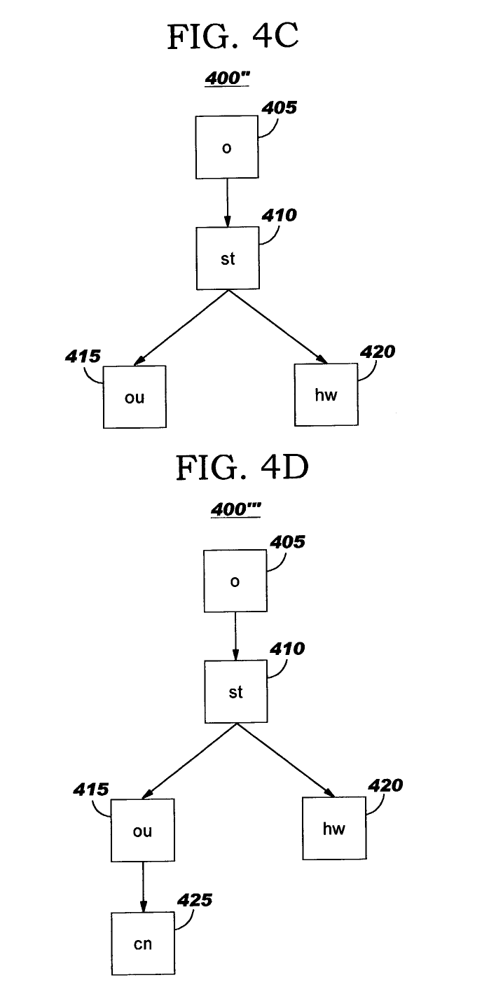

Preferred embodiments of the present invention will now be discussed in more detail with reference to FIGS. 4 (comprising FIGS. 4A-4D) through 6.

As stated earlier, the LDAP DIT is a tree of data elements that can each be uniquely identified by a distinguished name. Each level in the DIT typically represents a logical grouping of data elements. Employees are usually grouped with similar employees, and departments are usually grouped geographically (e.g., by site) or by the parent department, for example. The DIT index disclosed herein takes advantage of this logical grouping. Many applications that access directories (or otherwise interact with a DIT, such as the load-balancing server that determines where to route inbound LDAP queries) do not need to maintain the data values stored within the distinguished name. By removing the attribute values from the distinguished names of the DIT, as disclosed herein, the levels still represent the logical grouping. The LDAP DIT index of the present invention is therefore a representation of all the possible attribute type combinations in the underlying LDAP DIT.

According to preferred embodiments, the LDAP DIT Index is created using an ordered traversal of the LDAP DIT. The algorithm below shows the process that is preferably used to create the index from an LDAP DIT:

1. Create a node for each unique child attribute type of the current data element.

2. Select the next child data element of the current data element.

3. Repeat Step 1 until all child data elements have been processed.

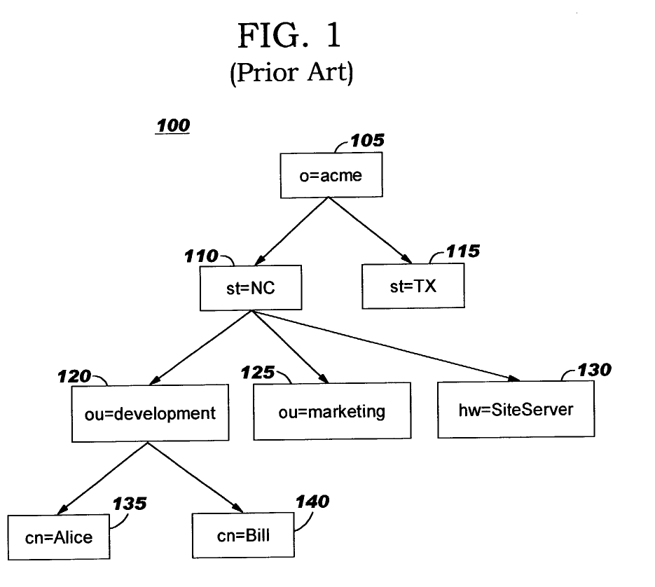

Reference is now made to FIGS. 4A-4D to illustrate how this algorithm creates an index for the example DIT 100 of FIG. 1.

The index is initially empty as the traversal of the LDAP DIT begins with the root data element. At Step 1 of the algorithm, the only child element at this point is the root element. Therefore, on the first pass through the algorithm, a node is created for the attribute type of this root element. With reference to the example DIT 100 in FIG. 1, the attribute type of root element 105 is “o”, and thus a single node 405 is created in the index 400 of FIG. 4A, using the “o” attribute type. Continuing with the processing of the root element, Step 2 of the algorithm selects the next child data element, which in DIT 100 is this root data element 105 (“o=acme”). Step 3 then begins a recursive invocation of the algorithm, for processing the selected child element.

After having selected child element 105, Step 1 of the algorithm detects that there are two child elements of this selected element, but that they have the same (i.e., non-unique) attribute type. Accordingly, a single node 410 is created in the index 400′ of FIG. 4B using the attribute type “st” of these child elements. Step 2 then selects the next child data element, which in the example DIT 100 is data element 110 (“st=NC”). Step 3 then recursively processes this child element.

The selected child element 110 has three child elements, but only two of the attribute types at this level are unique. Step 1 therefore creates two nodes 415, 420 in index 400″ of FIG. 4C, one for the “ou” attribute type of child elements 120, 125 and one for the “hw” attribute type of child node 130. Step 2 then selects the next child data element of the current data element, and therefore child data element 120 (“ou=development”) is selected in the example DIT 100 of FIG. 1. As before, Step 3 recursively processes this newly-selected child element.

There are two child elements at this level, but they have the same attribute type of “cn”. Thus, Step 1 creates a single node 425 in the index 400′″ for this “cn” attribute type. There are no more child elements to be selected by Step 2, and therefore the LDAP DIT index for DIT 100 has been created as shown in FIG. 4D.

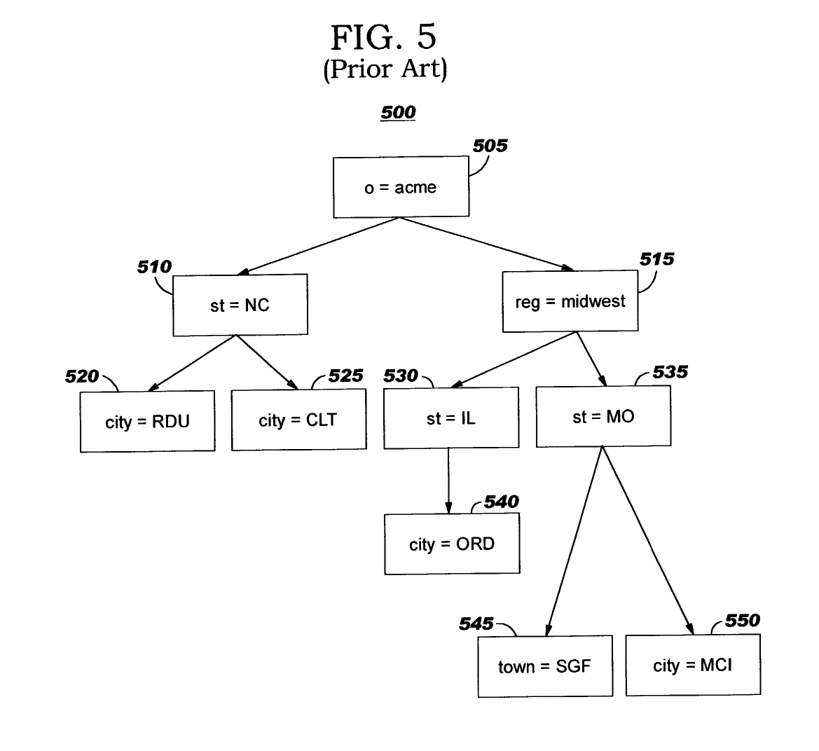

Use of the algorithm of preferred embodiments will now be illustrated with reference to another sample tree, which is shown at 500 in FIG. 5. (It should be noted that this sample tree 500 has been constructed merely for illustrating operation of the algorithm of preferred embodiments, and may not be representative of attribute types that would be present in an actual DIT.)

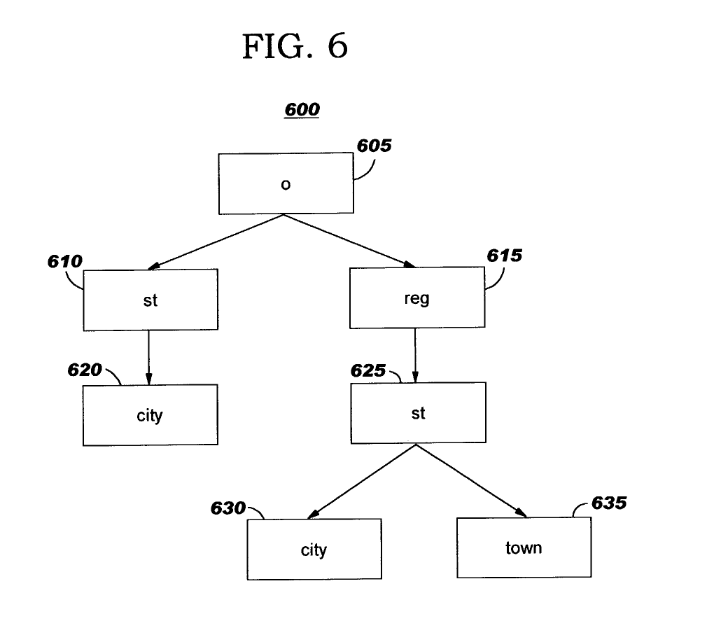

Again, the index is initially empty, and the traversal of the LDAP DIT begins with the root data element. At Step 1 of the algorithm on the first pass, a node is created for the attribute type of this root element. With reference to the example DIT 500 in FIG. 5, the attribute type of root element 505 is again “o”, and thus a single node 605 is created in the index 600 of FIG. 6 using this “o” attribute type. Step 2 of the algorithm then selects the next child data element, which in DIT 500 is data element 505 (“o=acme”), and Step 3 begins a recursive invocation of the algorithm to process the selected child element.

On this next iteration, Step 1 of the algorithm detects that there are two child elements of the current node, each having a unique attribute type. Accordingly, two nodes 610, 615 are created in the index 600 using these attribute types “st” and “reg” (which, in the example, is an abbreviation for “region”). Step 2 then selects the next child data element, which in the example DIT 500 is data element 510 (“st=NC”). Step 3 then recursively processes this child element.

The selected child element 510 has two child elements 520, 525, but only a single unique attribute type. Step 1 therefore creates a single node 620 in index 600 for this “city” attribute type. Step 2 then selects the next child data element of the current data element, which in the example DIT 500 causes child data element 515 (“reg=midwest”) to be selected. Step 3 then recursively processes this newly-selected child element.

This selected data element has two child elements 530, 535, but they have the same attribute type of “st”. Thus, Step 1 creates a single node 625 in the index 600 for this “st” attribute type. Step 2 then selects the next child data element, which is data element 530, and Step 3 invokes the recursive processing of this element.

On this iteration, Step 1 of the algorithm creates a node 630 for the single attribute type “city” which is present in the DIT in child element 540. Step 2 then selects the next child data element, which in this case is data element 535 (a sibling of the previously-selected child element 530). Step 3 causes this data element to be recursively processed.

Step 1, on this iteration, detects two unique attribute types “town” and “city” in the child data elements 545, 550. Since the “city” attribute is already represented in the index by node 630, another node 635 is only created to represent the “town” attribute type in index 600. At this point, there are no more child elements to be selected by Step 2, and therefore the LDAP DIT index for DIT 600 has been created as shown in FIG. 6.

The LDAP DIT index of the present invention creates a compressed version of an LDAP DIT by using only the distinguished name attribute types. The logical groupings at levels in the LDAP DIT allow applications to map many distinguished names to a single node in the index. Once created, the index can be used by any LDAP application to help manage distinguished name sensitive operations, such as distributed directories, load balancing, and privacy monitoring. The LDAP DIT index can enumerate all the possible distinguished names in the LDAP DIT with a fraction of the resources required when using a prior art approach.

When using the DIT index, its nodes may be tagged or marked with information, where this information may be determined according to the needs of the application that will be using the index. When the index is used for routing queries to servers providing a distributed directory, for example, the server that performs the routing function needs information about which of the distributed directory servers stores information having particular attribute values. One, or perhaps a small subset, of the servers typically stores directory entries in selected logical groupings (e.g., for DNs having selected attribute types or ranges of values). Suppose, with reference to the index in FIG. 6, that servers which will be designated for purposes of illustration as “A”, “B”, and “C” store information for DNs having attribute types of “st, reg, o”, but that only server “C” stores DNs having attribute types of “town, st, reg, o”. In this case, index node 625 may be tagged with the server designations “A”, “B”, and “C”, and node 630 may be tagged with server designation “C”.

In a load balancing scenario, multiple servers typically store identical directory entries. The server that performs the load balancing function (i.e., that selects a destination for an inbound query) may store just the DIT index of the present invention, rather than the entire DIT of the prior art, saving storage space and reducing processing overhead. Nodes of the DIT index may be tagged with more than one server designation to indicate that any of these servers can process queries for a DN constructed using the attribute type sequence represented by the tagged node (i.e., the attributes from this node to the root).

In actual practice, the server designations used to tag index nodes are preferably comprised of each server's network address or a name (or other identifier) that uniquely resolves to the network address.

In the general case, tagging of nodes of the DIT index may be used to indicate a relationship (or potential relationship) between a distinguished name and the object class used to describe its data. For example, it may be the case that each DN having a “cn” attribute type for its leaf node (or each DN of a form such as “cn, o, c”) corresponds to some type of “person” class (whether the classes using this attribute actually define an employee, spouse, systems administrator, or simply a generic person, as discussed earlier). It may be useful for an application to be able to quickly identify such DNs, and therefore a DIT index according to the present invention may be tagged with an appropriate indicator at all corresponding index nodes.

In addition to the examples which have been discussed, the DIT index of the present invention may be used in many other scenarios, and may be used for triggering functions at the index nodes in an application-specific manner. As one example of using the index for triggering functions, the DIT index disclosed herein has been advantageously deployed for privacy management in the LDAP Monitor function of IBM's Tivoli Privacy Manager for e-business. Privacy management is of serious concern to many people, and enterprises that store personal information about people (whether those people are employees of the enterprise, or its customers, etc.) need to take care to protect the privacy of that stored information. In fact, studies have shown that many end users provide false personal information when filling out forms on the Internet, due to their concern about how the collected data will be used. If an enterprise is to make beneficial use of the personal information, then steps must be taken to ensure that people feel comfortable in providing accurate input. For the LDAP Monitor deployment, the DIT index disclosed herein is tagged to indicate which nodes correspond to object classes that store personally-identifiable information (“PII”). When queries are submitted to a directory, LDAP Monitor (or an analogous function) can consult the tagged DIT index to determine whether an outbound response may reflect PII. In the example DIT indexes that have been discussed herein with reference to FIGS. 4 and 6, suppose that leaf nodes having attribute types “cn, ou, st, o” (see node 425 of FIG. 4D) correspond to object classes that store PII. In this case, node 425 may be tagged to indicate that PII is present here. On the other hand, it is unlikely that leaf nodes having attribute types “town, st, reg, o” or “city, st, reg, o” (see nodes 630, 635 of FIG. 6) will correspond to object classes that store PII. Therefore, nodes 630, 635 may be tagged to indicate that such information is not present. Thus, accessing the tagged DIT index enables a very quick, efficient comparison of the attribute types for a requested DN to determine whether the response itself may contain PII. As a result, an enterprise's privacy policy processing may be selectively invoked before returning a response that contains PII. (This privacy processing is beyond the scope of the present invention, but may include functions such as modifying data values to ensure that an individual's PII is made anonymous, or perhaps suppressing the PII completely.)

Other types of filtering or triggering functions may be adapted to use the DIT index of the present invention. Such other uses may become apparent to one of skill in the art once the teachings disclosed herein are known and are considered to be within the scope of the present invention.

A regular expression approach to mapping nodes of a directory is provided through use of the DIT index. This is in contrast to search filters of the prior art, which only allow a wildcard-type function at the leaf node of a DN; the present invention allows this function for the entire path through the hierarchical tree.

As has been demonstrated, the present invention defines techniques for creating an index of data stored in directories. The index disclosed herein requires less storage space, and may be traversed more quickly, than the full directory information tree structures of the prior art. The DIT index disclosed herein provides an efficient way to gain information about portions of the LDAP DIT without having to maintain a copy of the entire directory or DIT. Techniques of the prior art often require mirroring a DIT at multiple locations, for example by replicating the DIT of each distributed directory at a server that performs query routing. As described above, the present invention allows the compressed or collapsed DIT index to be used at the routing server instead.

While preferred embodiments of the present invention have been described, additional variations and modifications in those embodiments may occur to those skilled in the art once they learn of the basic inventive concepts. In particular, while discussions herein refer to directories that are accessible using LDAP, this is by way of illustration and not of limitation: the disclosed techniques may be used with other types of data repositories and/or with access protocols analogous to LDAP without deviating from the scope of the present invention. Therefore, it is intended that the appended claims shall be construed to include preferred embodiments as well as all such variations and modifications as fall within the spirit and scope of the invention.

What is claimed is:

1. A method of creating an efficient index for a directory, comprising steps of:
programmatically determining, for each level of a multi-level hierarchy representing entries in a directory, each unique attribute type used by the entries at that level; and
programmatically building a multi-level hierarchical index, where each level of the hierarchical index contains an entry for each of the programmatically-determined unique attributes types in a corresponding level of the multi-level hierarchy representing the entries in the directory.

2. The method according to claim 1, wherein attribute values corresponding to the attribute types are not copied from the multi-level hierarchy representing the entries in the directory to the entries in the multi-level hierarchical index.

3. The method according to claim 1, further comprising the step of tagging one or more selected entries of the index with information pertinent to the selected entry.

4. The method according to claim 3, wherein the pertinent information identifies one or more servers that store, in entries of the directory, information accessible using one or more parameters that include the attribute type of the selected entry of the index.

5. The method according to claim 3, wherein the pertinent information is usable as a trigger for selectively invoking functionality.

6. The method according to claim 5, wherein the selectively-invoked functionality is selectable when a query is issued to the directory and the query specifies one or more parameters that include the attribute type of the selected entry of the index.

7. The method according to claim 1, wherein the directory is a Lightweight Directory Access Protocol (“LDAP”) directory.

8. A system for creating an efficient index for a directory, comprising:
means for programmatically determining, for each level of a multi-level hierarchy representing entries in a directory, each unique attribute type used by the entries at that level; and
means for programmatically building a multi-level hierarchical index, where each level of the hierarchical index contains an entry for each of the programmatically-determined unique attributes types in a corresponding level of the multi-level hierarchy representing the entries in the directory, and wherein hierarchical relationships among the levels of the multi-level hierarchy are preserved when building the multi-level hierarchical index.

9. The system according to claim 8, wherein attribute values corresponding to the attribute types are not copied from the multi-level hierarchy representing the entries in the directory to the entries in the multi-level hierarchical index.

10. The system according to claim 8, further comprising means for tagging one or more selected entries of the index with information pertinent to the selected entry.

11. The system according to claim 10, wherein the pertinent information identifies one or more servers that store, in entries of the directory, information accessible using one or more parameters that include the attribute type of the selected entry of the index.

12. The system according to claim 10, wherein the pertinent information is usable as a trigger for selectively invoking functionality.

13. The system according to claim 12, wherein the selectively-invoked functionality is selectable when a query is issued to the directory and the query specifies one or more parameters that include the attribute type of the selected entry of the index.

14. The system according to claim 8, wherein the directory is a Lightweight Directory Access Protocol (“LDAP”) directory.

15. A computer program product for creating an efficient index for a directory, the computer program product embodied on one or more computer-readable media and comprising:
computer-readable program code means for programmatically determining, for each level of a multi-level hierarchy representing entries in a directory, each unique attribute type used by the entries at that level; and
computer-readable program code means for programmatically building a multi-level hierarchical index, where each level of the hierarchical index contains an entry for each of the programmatically-determined unique attributes types in a corresponding level of the multi-level hierarchy representing the entries in the directory and wherein levels of the multi-level hierarchical index preserves relationship among corresponding levels of the multi-level hierarchy.

16. The computer program product according to claim 15, wherein attribute values corresponding to the attribute types are not copied from the multi-level hierarchy representing the entries in the directory to the entries in the multi-level hierarchical index.

17. The computer program product according to claim 15, further comprising computer-readable program code means for tagging one or more selected entries of the index with information pertinent to the selected entry.

18. The computer program product according to claim 17, wherein the pertinent information identifies one or more servers that store, in entries of the directory, information accessible using one or more parameters that include the attribute type of the selected entry of the index.

19. The computer program product according to claim 17, wherein the pertinent information is usable as a trigger for selectively invoking functionality.

20. The computer program product according to claim 19, wherein the selectively-invoked functionality is selectable when a query is issued to the directory and the query specifies one or more parameters that include the attribute type of the selected entry of the index.

21. The computer program product according to claim 15, wherein the directory is a Lightweight Directory Access Protocol (“LDAP”) directory.

22. A method of building an index for a directory repository, comprising steps of:
programmatically determining, for each level of a multi-level hierarchy representing entries in a directory repository, each unique attribute type used by the entries at that level;
programmatically building a multi-level hierarchical index, where each level of the hierarchical index contains an entry for each of the programmatically-determined unique attributes types in a corresponding level of the multi-level hierarchy representing the entries in the directory; and
charging a fee for carrying out the steps of programmatically determining and programmatically building.
